(19) United States
(12) Patent Application Publication
(10) Pub. No.: US 2006/0197435 A1
(43) Pub. Date: Sep. 7, 2006

(54) Emissive flat panel display device

(76) Inventors: Makoto Okai, Tokorozawa (JP); Takahiko Muneyoshi, Musashimurayama (JP); Tomio Yaguchi, Sagamihara (JP); Susumu Sasaki, Chiba (JP); Tetsuya Yamazaki, Fujisawa (JP); Jun Ishikawa, Mobara (JP); Nobuaki Hayashi, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/365,501

(22) Filed: Mar. 2, 2006

(30) Foreign Application Priority Data
Mar. 2, 2005 (JP) 2005-056862

(51) Int. Cl. H01J 63/04

(52) U.S. Cl. 313/496

(57) ABSTRACT

Two electrodes out of a cathode electrode, a gate electrode and a focusing gate electrode are formed on a same plane of a back substrate adjacent to each other, and this electrode structure is stacked in plural stages whereby the number of steps of printing process for forming the respective electrodes can be decreased and the alignment accuracy at the time of manufacturing the electrode structure can be largely alleviated. Further, by forming the cathode electrode and the gate electrode using the same material which contains carbon nanotubes, the alignment accuracy at the time of manufacturing the electrode structure can be largely alleviated. Accordingly, it is possible to manufacture an emissive flat panel display device easily and at a low cost using printing coating process or the like which is usually used.

### CROSS-REFERENCE TO RELATED APPLICATION

The present application claims priority from Japanese application JP2005-056862 filed on Mar. 2, 2005, the content of which is hereby incorporated by reference into this application

### BACKGROUND OF THE INVENTION

1. Field of the Invention

The present invention relates to a display device which utilizes an emission of electrons into a vacuum, and more particularly, to an emissive flat panel display device including a back panel which is provided with cathode electrodes having electron sources formed of a nano-material and gate electrodes which control an emission quantity of electrons from the electron sources and a face panel which is provided with phosphor layers of a plurality of colors which emit light upon excitation of electron emitted from the back panel and anode electrodes.

As a display device which exhibits the high brightness and the high definition, color cathode ray tubes have been popularly used conventionally. However, along with the recent request for the higher quality of images of information processing equipment or television broadcasting, the demand for planar display devices which are light in weight and require a small space while exhibiting the high brightness and the high definition has been increasing.

As typical examples, liquid crystal display devices, plasma display devices and the like have been put into practice. Further, particularly, as display devices which can realize the higher brightness, it is expected that various kinds of panel-type display devices including an electron emission type display device which utilizes an emission of electrons from electron sources into a vacuum and an organic EL display device which is characterized by low power consumption will be commercialized soon. Here, the plasma display device, the electron emission type display device or the organic EL display device which requires no auxiliary illumination light source is referred to as a self-luminous flat panel display device or an emissive flat panel display device.

Among such flat panel display devices, as the above-mentioned electron emission type display device, a display device having a cone-shaped electron emission structure which was invented by C. A. Spindt et al, a display device having an electron emission structure of a metal-insulator-metal (MIM) type, a display device having an electron emission structure which utilizes an electron emission phenomenon based on a quantum theory tunneling effect (also referred to as “a surface conduction type electron source), and a display device which utilizes an electron emission phenomenon which a diamond film, a graphite film and nanotubes represented by carbon nanotubes and the like possesses have been known.

The electron emission type display device which is one example of the emissive flat panel display device is constituted by sealing a back panel which forms electron-emission-type electron sources and gate electrodes which constitute control electrodes on an inner surface thereof and a face panel which includes phosphor layers of a plurality of colors and an anode electrode (an anode) on an inner surface thereof which opposedly faces the back panel while interposing a sealing frame between inner peripheries of both panels and by holding the inside defined by the back panel, the face panel and the sealing frame in a vacuum state.

The back panel includes a plurality of cathode electrodes having electron sources which extend in the first direction, are arranged in parallel in the second direction which crosses the first direction and gate electrodes which extend in the second direction and are arranged in parallel in the first direction on the back substrate which is preferably made of glass, ceramics or the like. Then, in response to the potential difference between the cathode electrode and the gate electrode, an emission quantity (including ON and OFF of the emission) of electrons from the electron sources is controlled.

Further, the face panel includes phosphor layers and an anode electrode on the face substrate which is formed of a light transmitting material such as glass. The sealing frame is fixedly adhered to inner peripheries of the back panel and the face panel using an adhesive material such as frit glass. The degree of vacuum in the inside defined by the back panel, the face panel and the sealing frame is, for example, approximately 10⁻⁵ to 10⁻⁷ Torr. When the field emission type display device has a large-sized display screen, the back panel and the face panel both panels are fixed to each other by interposing gap holding members (referred to as spacers or partition walls) therebetween thus holding the gap between both substrates at a given distance.

Here, as the literature which discloses a related art on the emissive flat panel display device which adopts carbon nanotubes which are a typical example of nanotubes as electron sources, many literatures are reported including following literature 1.

[literature 1]

Applied Physics Letters, vol. 80 (21) pt. 4045-4047 (2002)

However, in the emissive flat panel display device which uses carbon nanotubes as the electron sources, it is important to constitute the electrode structure which can sufficiently make use of the excellent electron emission characteristics of the carbon nanotubes. As one of requirements for constituting such an electrode structure, for a gate electrode operation with a low voltage, it is necessary to control a distance between the electron source and the gate electrode within a range of approximately several μm to tens μm. Such a control of the distance requires the application of photolithography processing which largely impedes the reduction of cost.

### SUMMARY OF THE INVENTION

Accordingly, the present invention has been made to overcome the above-mentioned drawbacks of the related art and it is an object of the present invention to provide an emissive flat panel display device which uses a nanomaterial represented by carbon nanotubes as electron sources, wherein the electrode structure which can sufficiently make use of the performance of the nanomaterial electron sources can be manufactured using a coating process which is usually used easily and at a low cost.

To achieve such an object, in an emissive flat panel display device according to the present invention, two electrodes out of a cathode electrode, a gate electrode and a focusing gate electrode are formed on a same plane adjacent to each other, the electrode structure is stacked in plural stages, thus decreasing the number of printing process for forming respective electrodes and hence, the alignment accuracy at the time of manufacturing the electrode structure can be largely attenuated whereby the drawback of the related art can be overcome.

Further, according to another emissive flat panel display device of the present invention, preferably, in the above-mentioned constitution, the cathode electrode and the gate electrode are formed on a first stage, and a bus line of the gate electrode and the focusing gate electrode are formed on a second stage whereby the drawback of the related art can be overcome.

Further, according to another emissive flat panel display device of the present invention, preferably, in the above-mentioned constitution, a cathode electrode and a gate electrode are formed on a first stage, a bus line of the gate electrode is formed on a second stage, and a first focusing gate electrode and a second focusing gate electrode which are formed by electrically separating a focusing gate electrode are formed on a third stage whereby the drawbacks of the related art can be overcome.

Further, according to another emissive flat panel display device of the present invention, preferably, in the above-mentioned constitution, by forming an electron source layer which contains a nanomaterial on a surface of the cathode electrode, the drawbacks of the related art can be overcome.

Further, according to another emissive flat panel display device of the present invention, preferably, in the above-mentioned constitution, by allowing the cathode electrode to contain a nanomaterial which constitutes an electron source, the drawback of the related art can be overcome.

Further, according to another emissive flat panel display device of the present invention, preferably, in the above-mentioned constitution, the cathode electrode and the gate electrode contains a nanomaterial which constitutes the electron source whereby the drawback of the related art can be overcome.

Further, according to another emissive flat panel display device of the present invention, preferably, in the above-mentioned constitution, the nanomaterial which constitutes the electron source is formed of either one of nanotubes, nanocoil or a nano-sized material which is made of carbon and nanotubes, nanocoil or a nano-sized material which contains two elements or more out of three elements consisting of carbon, boron and nitrogen whereby the drawback of the related art can be overcome.

Here, the present invention is not limited to the above-mentioned respective constitutions and the constitutions which are described in embodiments described later, and various modifications can be made without departing from the technical concept of the present invention.

According to the emissive flat panel display device according to the present invention, two electrodes out of the cathode electrode, the gate electrode and the focusing gate electrode are formed on the same plane adjacent to each other, and the electrode structure is stacked in plural stages and hence, the number of steps of printing process for forming respective electrodes is largely reduced, and the alignment accuracy at the time of manufacturing the electrode structure can be largely alleviated whereby it is possible to obtain an extremely excellent effect that the emissive flat panel display device can be manufactured easily and at a low cost using printing coating process or the like which is usually used.

Further, according to the emissive flat panel display device according to the present invention, by allowing the cathode to contain the nanomaterial which becomes the electron source, it is possible to realize a favorable electric contact between the cathode electrode and the electron source and hence, the electric resistance between the cathode electrode and the electron source can be reduced whereby it is possible to obtain an extremely excellent effect that the electrode structure which sufficiently makes use of the excellent performance of the nanomaterial as the electron source can be realized.

Further, according to the emissive flat panel display device of the present invention which uses the nanomaterial as the electron source, by forming the cathode electrode and the gate electrode using the same material which contains the nanomaterial, the electric resistance between the cathode electrode and the electron source can be reduced and, at the same time, the alignment accuracy at the time of manufacturing the electrode structure can be largely alleviated and hence, it is possible to obtain an extremely excellent effect that the emissive flat panel display device can be manufactured easily at a low cost using the printing coating process which is usually used.

### BRIEF EXPLANATION OF DRAWINGS

FIG. 1 is a developed perspective view of an essential part of an emissive flat panel display device according to an embodiment 1 as viewed from an oblique upper position;

FIG. 2 is a developed perspective view of an essential part of the emissive flat panel display device according to the embodiment 1 as viewed from the oblique below position;

FIG. 3 is a plan view of an essential part for schematically explaining a constitutional example of a back panel in the embodiment 1;

FIG. 4 is a plan view of an essential part for schematically explaining a constitutional example of a face panel in the embodiment 1;

FIG. 5A is a plan view for schematically explaining the constitutional example of the back panel in the embodiment 1;

FIG. 5B is an enlarged view of an essential part in FIG. 5A;

FIG. 6A is a plan view for schematically explaining the constitutional example of the face panel which constitutes the emissive flat panel display device of the embodiment 1;

FIG. 6B is an enlarged view of an essential part in FIG. 5B;

FIG. 7 is an explanatory view of a process for manufacturing the constitutional example of the back panel of the emissive flat panel display device of the present invention;

FIG. 8 is an explanatory view following FIG. 7 of the process which manufactures the constitutional example of the back panel of the emissive flat panel display device of the present invention;

FIG. 9 is an explanatory view following FIG. 8 of the process which manufactures the constitutional example of the back panel of the emissive flat panel display device of the present invention;

FIG. 10 is an explanatory view following FIG. 9 of the process which manufactures the constitutional example of the back panel of the emissive flat panel display device of the present invention;

FIG. 11 is an explanatory view following FIG. 10 of the process which manufactures the constitutional example of the back panel of the emissive flat panel display device of the present invention;

FIG. 12 is an explanatory view of a process for manufacturing another constitutional example of the back panel of the emissive flat panel display device of the present invention;

FIG. 13 is an explanatory view following FIG. 12 of the process which manufactures the constitutional example of the back panel of the emissive flat panel display device of the present invention;

FIG. 14 is an explanatory view following FIG. 13 of the process which manufactures the constitutional example of the back panel of the emissive flat panel display device of the present invention;

FIG. 15 is an explanatory view following FIG. 14 of the process which manufactures the constitutional example of the back panel of the emissive flat panel display device of the present invention;

FIG. 16 is an explanatory view of a process for manufacturing constitutional example of the back panel of the emissive flat panel display device of the present invention;

FIG. 17 is an explanatory view following FIG. 16 of the process which manufactures the constitutional example of the back panel of the emissive flat panel display device of the present invention;

FIG. 18 is an explanatory view following FIG. 17 of the process which manufactures the constitutional example of the back panel of the emissive flat panel display device of the present invention;

FIG. 19 is an explanatory view following FIG. 18 of the process which manufactures the constitutional example of the back panel of the emissive flat panel display device of the present invention;

FIG. 20 is an explanatory view following FIG. 19 of the process which manufactures the constitutional example of the back panel of the emissive flat panel display device of the present invention;

FIG. 21 is an explanatory view following FIG. 20 of the process which manufactures the constitutional example of the back panel of the emissive flat panel display device of the present invention;

FIG. 22 is an explanatory view of a process for manufacturing still another constitutional example of the back panel of the emissive flat panel display device of the present invention;

FIG. 23 is an explanatory view following FIG. 22 of the process which manufactures the constitutional example of the back panel of the emissive flat panel display device of the present invention;

FIG. 24 is an explanatory view following FIG. 23 of the process which manufactures the constitutional example of the back panel of the emissive flat panel display device of the present invention;

FIG. 25 is an explanatory view following FIG. 24 of the process which manufactures the constitutional example of the back panel of the emissive flat panel display device of the present invention;

FIG. 26 is an explanatory view following FIG. 25 of the process which manufactures the constitutional example of the back panel of the emissive flat panel display device of the present invention;

FIG. 27 is a plan view showing the structure of FIG. 26;

FIG. 28 is an explanatory view of a process for manufacturing another constitutional example of the back panel of the emissive flat panel display device according to the present invention;

FIG. 29 is an explanatory view following FIG. 28 of the process which manufactures the constitutional example of the back panel of the emissive flat panel display device of the present invention;

FIG. 30 is an explanatory view following FIG. 29 of the process which manufactures the constitutional example of the back panel of the emissive flat panel display device of the present invention;

FIG. 31 is a plan view showing the structure of FIG. 30;

FIG. 32 is an explanatory view of a process for manufacturing another constitutional example of the back panel of the emissive flat panel display device according to the present invention;

FIG. 33 is an explanatory view following FIG. 32 of the process which manufactures the constitutional example of the back panel of the emissive flat panel display device of the present invention;

FIG. 34 is an explanatory view following FIG. 33 of the process which manufactures the constitutional example of the back panel of the emissive flat panel display device of the present invention;

FIG. 35 is an explanatory view following FIG. 34 of the process which manufactures the constitutional example of the back panel of the emissive flat panel display device of the present invention;

FIG. 36 is an explanatory view following FIG. 35 of the process which manufactures the constitutional example of the back panel of the emissive flat panel display device of the present invention;

FIG. 37 is a plan view showing the structure of FIG. 36;

FIG. 38 is a perspective view with a part broken away for explaining one example of the whole structure of the emissive flat panel display device according to the present invention; and

FIG. 39 is a cross-sectional view taken along a line A-A′ in FIG. 38.

### DESCRIPTION OF THE PREFERRED EMBODIMENTS

The present invention is an emissive flat panel display device having a back panel and a face panel.

The back panel includes a large number of cathode electrodes which extend in a first direction, are arranged in parallel in a second direction which intersects the first direction and include electron sources on surfaces thereof, and a large number of gate electrodes which extend in the second direction, are arranged in parallel in the first direction and to which a potential which controls a quantity of electrons emitted from the electron sources at intersecting portions with the cathode electrodes is applied, and focusing gate electrodes which are electrically insulated from the cathode electrodes and the gate electrodes and controls a spreading angle of electron beams emitted from the electrons sources on the cathode electrodes. A main region is constituted of a large number of pixels which are formed on the intersecting portions of the cathode electrodes and the gate electrodes.

A face panel includes a plurality of phosphor layers of plural colors which emit lights upon excitation of the electron beams taken out from the electron sources formed on the display region of the back panel and an anode electrode.

The display device includes a cathode electrode bus line which electrically connects the cathode electrodes for every set in a state that the cathode electrodes are divided into a plurality of sets, a gate electrode bus line which electrically connects the gate electrodes for every set in a state that the gate electrodes are divided into a plurality of sets, and a focusing gate electrode bus line which electrically connect the focusing gate electrodes for every set in a state that the focusing gate electrodes are divided into a plurality of sets.

The electrode structure in which two electrodes out of the cathode electrode, the gate electrode and the focusing electrode are formed on a same plane adjacent to each other is provided in plural stages.

Hereinafter, embodiments of the present invention are explained in conjunction of drawings showing the embodiments.

### Embodiment 1

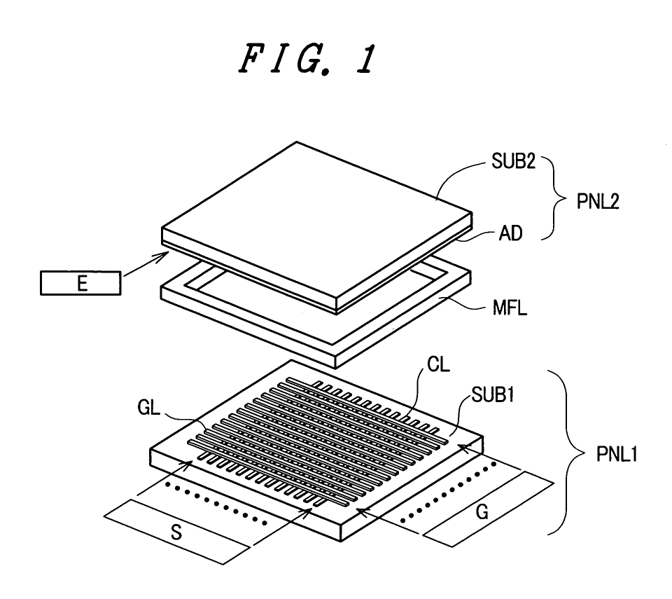

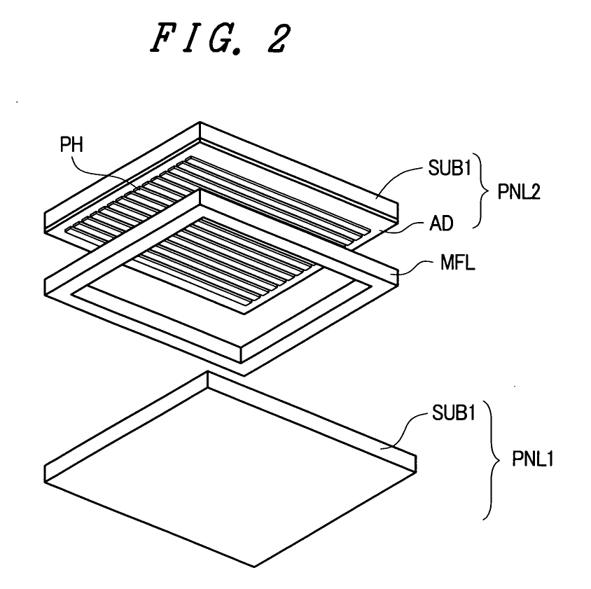

FIG. 1 and FIG. 2 are schematic views for explaining the constitution of an embodiment 1 of an emissive flat panel display device according to the present invention, wherein FIG. 1 is a developed perspective view of an essential part of the emissive flat panel display device as viewed from an oblique above position, and FIG. 2 is a developed perspective view of an essential part of the emissive flat panel display device as viewed from the oblique below position. The emissive flat panel display device is constituted by laminating a back substrate SUB1 which constitutes a back panel PNL1 and a face substrate SUB2 which constitutes a face panel PNL2 by way of a sealing frame MFL.

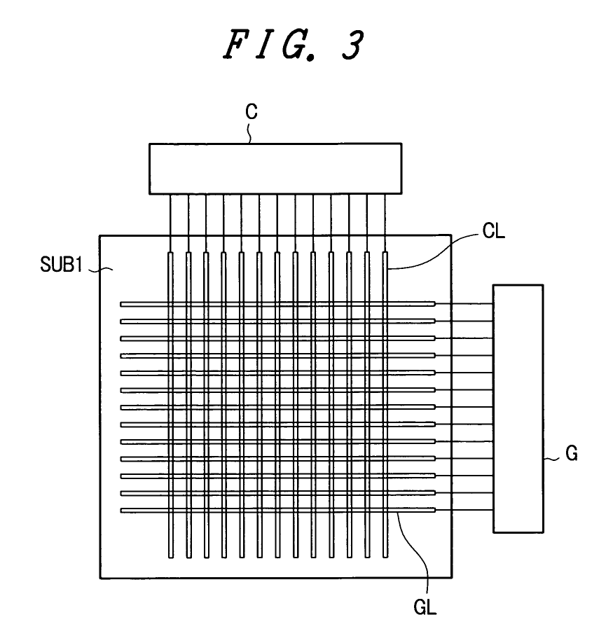

Further, FIG. 3 is a plan view of an essential part showing an inner surface of the back substrate SUB1 of the emissive flat panel display device as viewed from above. In FIG. 3, on the back substrate SUB1, a large number of cathode electrodes CL which extend in one direction and are arranged in parallel in another direction which intersects the one direction and a large number of gate electrodes GL which extend in the above-mentioned another direction and are arranged in parallel in the above-mentioned one direction are formed. The cathode electrodes CL and the gate electrodes GL are stacked by way of an insulating layer not shown in the drawing, and carbon nanotubes (nanomaterial) electron sources are formed on the respective intersecting portions.

With respect to the cathode electrodes CL which supply electrons to the electron sources, the respective cathode electrodes CL are divided into plural sets and the cathode electrodes CL of every set are electrically connected to a cathode electrode bus line. Further, with respect to the gate electrodes GL, the respective gate electrodes GL are divided into plural sets and the gate electrodes GL of every set are electrically connected to a gate electrode bus line. Further, also with respect to focusing gate electrodes described later, the respective focusing gate electrodes are divided into plural sets and the focusing gate electrodes of every set are electrically connected to a focusing gate bus line. Further, by respectively selecting portions of the cathode electrode bus line and the gate electrode bus line, an electron beam group which emits electrons from electron sources at the designated positions is constituted.

A cathode signal (video signal) is supplied to the cathode electrodes CL which are formed on the back substrate SUB1 from a cathode signal source (video signal source) S, while a gate signal (scanning signal) is supplied to the gate electrodes GL from a gate signal source (scanning signal source) G. Further, electron beams are emitted from the electron source of the cathode electrode CL which intersects the gate electrode GL which is selected in response to the gate signal.

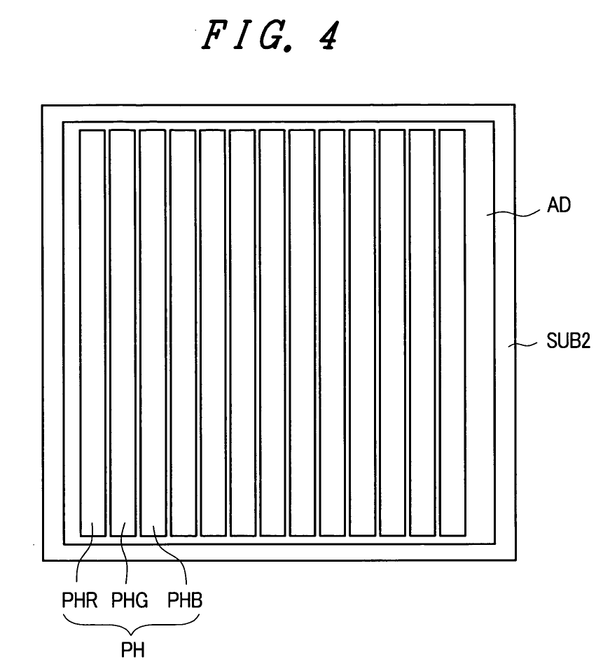

Further, FIG. 4 is a plan view of an essential part showing an inner surface side of the face substrate SUB2 of the emissive flat panel display device as viewed from above. In FIG. 4, on a display region formed on an inner surface of the face substrate SUB2, a plurality of red phosphor layers PHR, a plurality of green phosphor layers PHG and a plurality of blue phosphor layers PHB are formed in conformity with positions of the back substrate SUB1 shown in FIG. 3 at which the electron sources are arranged in a stripe array thus forming the phosphor layers PH. Here, the phosphor layers PH may be arranged in a dot array. Still further, these respective red phosphor layers PHR, green phosphor layers PHG and blue phosphor layers PHB are partitioned from each other by a black matrix film not shown in the drawing, and a metal back film is formed over a whole surface of back surfaces of these phosphor layers PH and the black matrix film.

Further, on the face substrate SUB2, as shown in FIG. 4, an anode electrode (anode) AD is formed below the phosphor layers PH. Here, the anode electrode AD may be formed on the phosphor layers PH. To the anode electrode AD, a predetermined anode voltage is applied from a high voltage source E shown in FIG. 1. Electrons which are emitted from the electron sources of the cathode electrodes CL are accelerated by the high voltage applied from the anode electrode AD and impinge on the predetermined phosphor layers PH and allow the phosphor layers PH to emit light with predetermined colors. By controlling the emission of light of the phosphor layers PH over the whole area of the display region of the face substrate SUB2, it is possible to display a two-dimensional image.

Here, in the flat panel display device having a large screen size, to hold a distance between the electron sources formed on the back substrate SUB1 and the phosphor layers PH formed on the face substrate SUB2 at a predetermined value, a plurality of partition walls (spacers) made of a thin glass plate or the like are arranged inside of the sealing frame MFL at a predetermined interval.

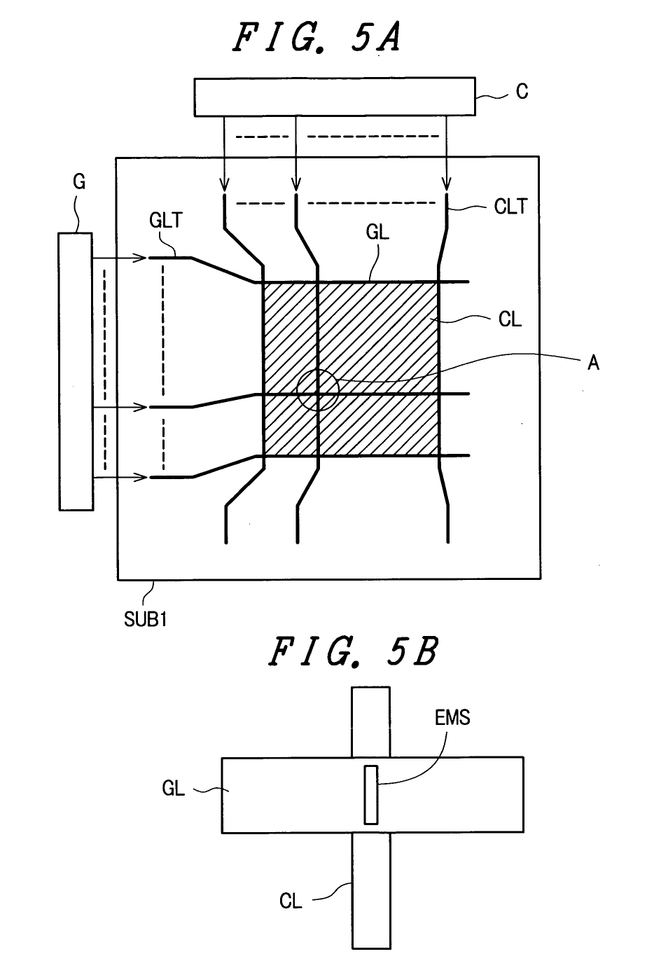

FIG. 5A and FIG. 5B are plan views for schematically explaining a constitutional example of the back panel in the embodiment 1, wherein FIG. 5A is a whole constitutional view and FIG. 5B is an enlarged view of an essential part in FIG. 5A. On the back substrate SUB1 which constitutes the back panel, a plurality of cathode electrodes CL are formed in the vertical direction in FIG. 5B, while a plurality of gate electrodes GL are formed in the horizontal direction in FIG. 5B. The cathode electrodes CL and the gate electrodes GL, although not shown in the drawing, intersect each other by way of the insulating layer and electron source portions EMS made of the above-mentioned carbon nanotubes are formed at respective intersecting portions.

The electron source portion EMS which contains the carbon nanotubes is, as mentioned previously, formed inside of the cathode electrode which is exposed to a bottom portion of a hole which penetrates the gate electrode GL and an insulating layer (not shown in the drawing) below the gate electrode GL. Each electron source portion EMS corresponds to a sub pixel which constitutes one pixel in a color display. One end of the respective cathode electrodes CL constitute a cathode electrode lead line CLT and a cathode signal (video signal) is supplied to the cathode electrode lead line CLT from a cathode signal source S. Further, one end of the respective gate electrodes GL constitute a gate electrode lead line GLT and a gate signal (scanning signal) is supplied to the gate electrode lead line GLT from a gate signal source G.

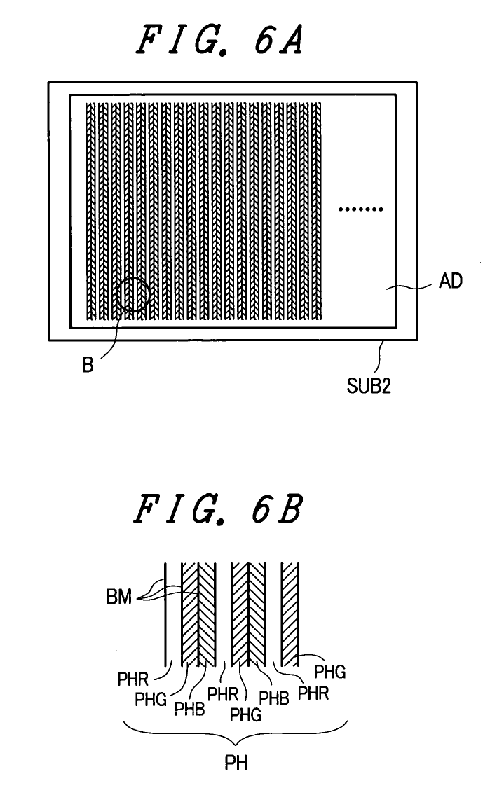

FIG. 6A and FIG. 6B are plan views for schematically explaining the constitutional example of the face panel which constitutes the emissive flat panel display device of the embodiment 1, FIG. 6A is a whole constitutional view and FIG. 6B is an enlarged plan view of an essential part in FIG. 6A. With respect to the face panel, the phosphor layers PH are formed on an inner surface of the face panel as films in a state that the respective phosphor layers PHR, PHG, PHB of red (R), green (G), blue (B) in a stripe shape are partitioned from each other by the light blocking layer (black matrix) BM thus forming a phosphor screen. The anode electrode AD having a film thickness of tens nm to hundreds nm is formed on the phosphor screen.

The phosphor screen is formed as follows. First of all, the black matrix BM in a stripe shape is formed at a position in the center between electron source portions EMS in conformity with a pitch in the lateral direction (horizontal direction) of the electron source portions EMS by coating slurry which is formed by mixing a light absorbing material and a photosensitive resin, mask exposure and a known lift-off method using hydrogen peroxide water.

Next, the respective phosphor layers PHR, PHG, PHB of red (R), green (G), blue (B) in a stripe shape are formed in a repeated pattern using a slurry method thus forming the phosphor layer PH in which the black matrix BM is arranged at both sides of each phosphor layer PHR, PHG, PHB. Further, after forming the respective phosphor layers PHR, PHG, PHB in a stripe shape, although not shown in the drawing, aluminum is vapor-deposited over the whole surface of the respective phosphor layers in a thickness of tens nm to hundreds nm, thus forming the anode electrode AD.

The face panel which is manufactured in this manner is laminated to the above-mentioned back panel by way of the sealing frame MFL, the electron sources and the phosphors are aligned with each other, and the inside is evacuated to create a vacuum and is sealed thus forming the display panel. Then, drive circuits and the like are added to the display panel to complete the emissive flat panel display device. Here, frit glass is used for sealing the face panel, the sealing frame MFL and the back panel. In sealing, frit glass is applied by coating to the sealing surface using a printing method or a dispenser coating method and is heated at a temperature of about 450° C. thus melting and adhering them together. Further, the vacuum evacuation of an inner space formed by sealing the face panel, the sealing frame and the back panel is performed by evacuating air from an air discharge pipe mounted on any one of the face panel, the sealing frame and the back panel (usually, at a proper position outside the display region of the back panel and inside the sealing frame), and the air discharge pipe is closed in a state that the vacuum arrives at a predetermined degree of vacuum thus forming the display panel.

In the display panel which is manufactured in this manner, by applying the cathode signal to the cathode electrodes CL, by applying the gate signal to the gate electrodes GL, and by applying the acceleration voltage which is a high voltage with respect to the cathode voltage CL to the acceleration electrode AD, it is possible to allow the display device to display an desired image of high quality.

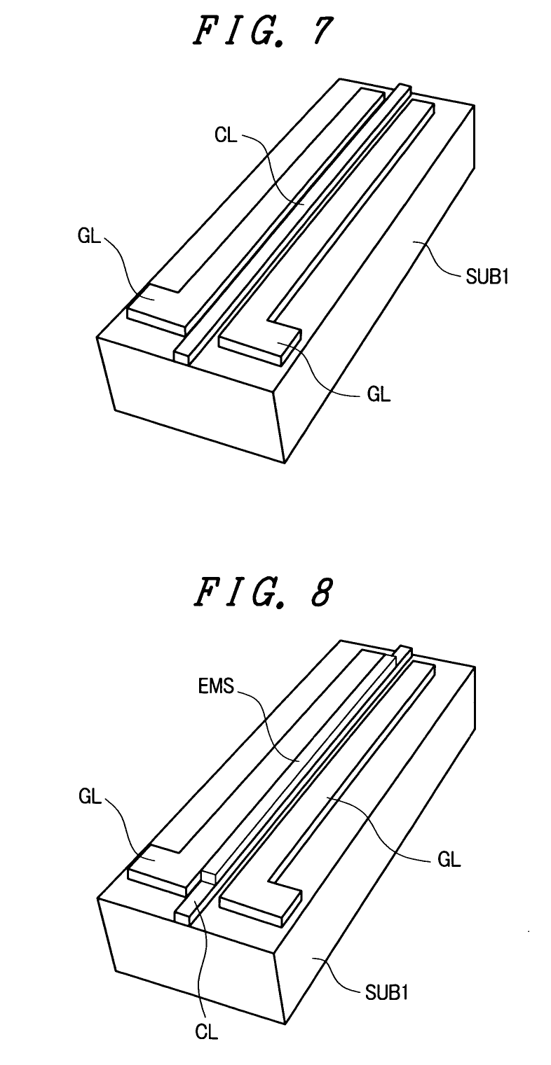

Next, structural examples of electron sources and the manufacturing process of the electron sources in the emissive flat panel display device according to the present invention are explained using enlarged perspective views of essential parts shown in FIG. 7 to FIG. 11. Here, in this embodiment, a sub pixel of the electron source array is described in detail in this embodiment.

First of all, as shown in FIG. 7, to the back substrate SUB1 which is preferably made of a glass plate, an electrode forming silver paste which is formed by impregnating silver fine particles into an organic solvent is applied by a screen printing method in a stripe shape and, thereafter, the paste is baked so as to form cathode electrodes CL and gate electrodes GL simultaneously. These cathode electrodes CL and the gate electrodes GL are formed on a same plane on the back substrate SUB1. A width of the cathode electrode CL is approximately 30 μm, and a distance between the cathode electrode CL and a stripe-shape cathode electrode not shown in the drawing arranged adjacent to the cathode electrode CL is approximately 240 μm. A distance between the cathode electrode CL and the gate electrode GL is approximately 30 μm. Further, the cathode electrode CL and the gate electrode GL contain silver fine particles having a particle size of approximately 1 μm and a film thickness of the cathode electrode CL and the gate electrode GL after baking is approximately 5 μm. 3840 pieces (1280×3) of cathode electrodes CL having the stripe structure are formed.

Next, as shown in FIG. 8, to a surface of the cathode electrode CL, a silver paste which is formed by allowing an organic solvent to contain the silver fine particles having a particle size of approximately 1 μm and multi-wall carbon nanotubes having a diameter of approximately 5 nm is applied by a screen printing method thus forming an electron source layer EMS.

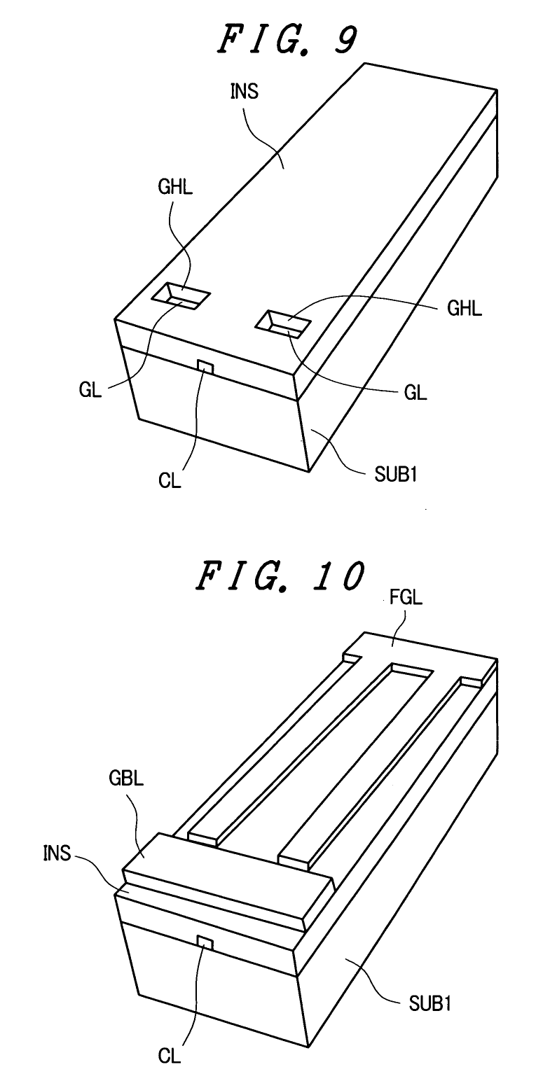

Next, as shown in FIG. 9, to the back substrate SUB1 on which the cathode electrode CL, the electron source layer EMS and the gate electrodes GL are formed, frit glass is applied by a screen printing method and is baked thus forming an insulating layer INS. In the insulating layer INS, gate electrode contact holes GHL which are communicated with the gate electrodes GL are formed at portions thereof which correspond to positions where the gate electrodes GL are formed. A film thickness of the insulating layer INS is approximately 5 μm after baking.

Next, as shown in FIG. 10, an electrode forming silver paste which is formed by impregnating silver fine particles into an organic solvent is applied to portions of the insulating layer INS which correspond to the gate electrode contact holes GHL and predetermined portions of the insulating layer INS by a screen printing method and is baked thus simultaneously forming a gate electrode bus line GBL and a focusing gate electrode FGL. The gate electrode bus line GBL and the focusing gate electrode FGL are constituted of silver fine particles having a particle size of approximately 1 μm and a film thickness of the gate electrode bus line GBL and the focusing gate electrode FGL is approximately 5 μm after baking. 720 pieces of gate electrode bus lines GBL and 720 pieces of focusing gate electrodes FGL are formed respectively.

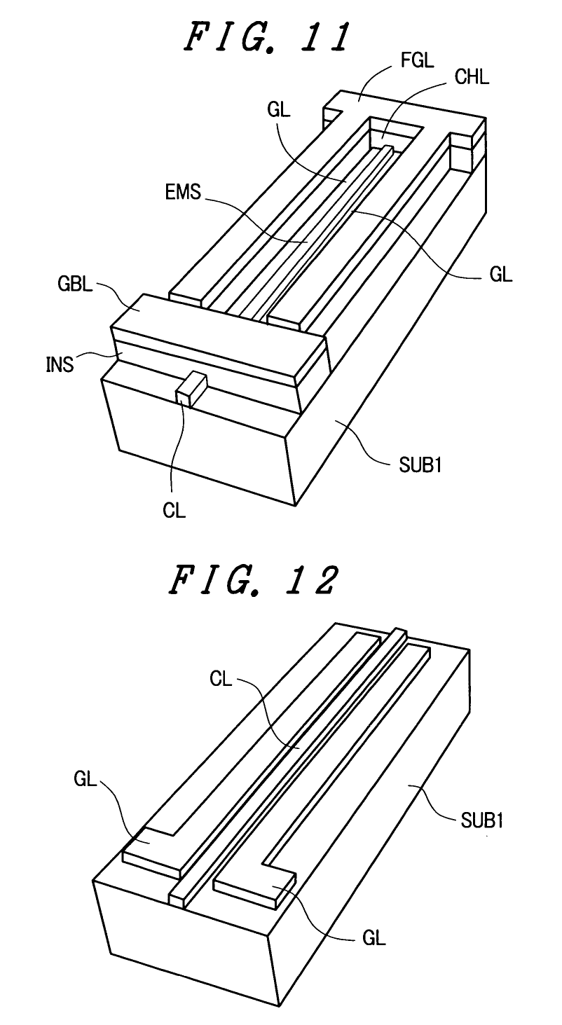

Next, as shown in FIG. 11, using the gate electrode bus line GBL and the focusing gate electrode FGL as masks, the insulating layer INS is etched by a dry etching method or a wet etching method thus forming an electron source hole CHL. Due to such a constitution, inside of the electron source hole CHL, the electron source layer EMS which is formed on the cathode electrode CL and portions of the gate electrodes GL arranged close to the cathode electrode CL side are exposed.

Finally, the surface treatment for forming raised carbon nanotubes is performed with respect to the electron source layer EMS. The surface treatment can be performed using a technique such as the laser irradiation, the plasma treatment or the mechanical treatment. In this manner, it is possible to form the carbon nanotubes electron source structure which can perform the gate operation and the electron beam focusing. In such an electron source structure, the electron source layer EMS on the cathode electrode CL and the gate electrode GL are formed adjacent to each other on the substantially coplanar surface of the back substrate SUB1.

The electron source structure having such a structure can, by applying a positive or negative voltage with respect to the cathode electrode CL to the focusing gate electrode FGL, control a spreading angle of emission beams from the cathode electrode CL.

Here, in this embodiment, although the cathode electrode CL, the gate electrode GL, the gate electrode bus line GBL and the focusing gate electrode FGL are made of silver, it is possible to use any metal which possesses the necessary electric conductivity. Further, it is also possible to use alloy or a metal multi-layered film. Still further, the formation by coating of the cathode electrode CL, the electron source layer EMS, the gate electrode GL, the gate electrode bus line GBL and the focusing gate electrode FGL is not limited to the screen printing and an ink jet method, other peculiar printing methods, an epitaxial growth method or the like can be also used.

### Embodiment 2

Next, another structural example of electron source and the manufacturing process of the structural example of the electron source in the emissive flat panel display device according to the present invention is explained using enlarged perspective views of essential parts shown in FIG. 12 to FIG. 15. Here, in this embodiment, a sub pixel of the electron source array is described in detail in these drawings.

First of all, as shown in FIG. 12, to the back substrate SUB1 which is preferably made of a glass plate, an electrode forming silver paste which is formed by containing silver fine particles into an organic solvent is applied by a screen printing method in a stripe shape and, thereafter, the paste is baked so as to form the stripe structure of the cathode electrodes CL and the stripe structure of the gate electrodes GL simultaneously. These cathode electrodes CL and the gate electrodes GL are formed on a same plane of the back substrate SUB1. A width of the stripe structure of the cathode electrode CL is approximately 30 μm and a distance between the cathode electrode CL and a stripe-shape cathode electrode arranged adjacent to the cathode electrode CL is approximately 240 μm, and a distance between the cathode electrode CL and the gate electrode GL is approximately 30 μm.

The cathode electrode CL and the gate electrodes GL contain silver fine particles having a particle size of approximately 1 μm and a film thickness of the cathode electrode CL and the gate electrodes GL after baking is approximately 5 μm. 3840 pieces (1280×3) of cathode electrodes CL having the stripe structure are formed.

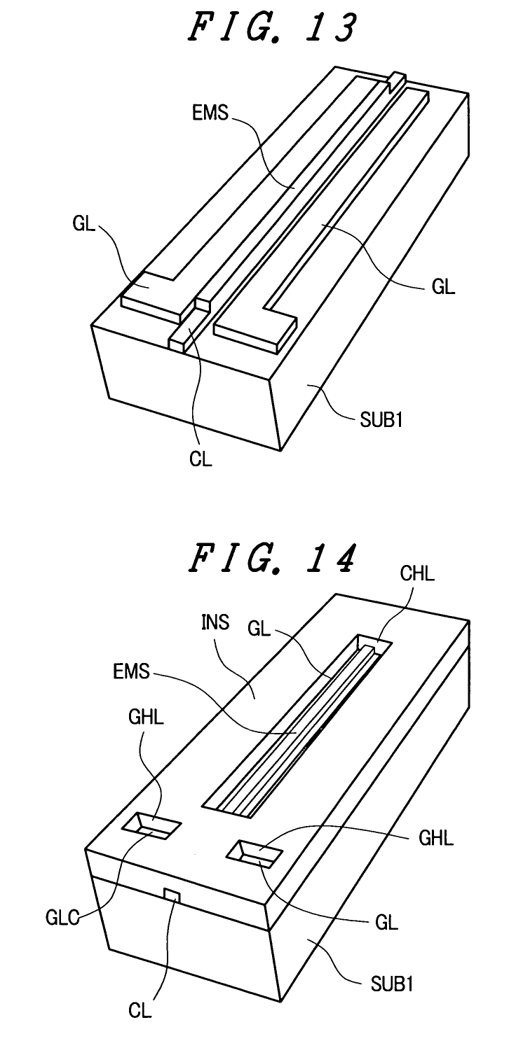

Next, as shown in FIG. 13, to the cathode electrode CL, a silver paste which is formed by allowing an organic solvent to contain the silver fine particles having a particle size of approximately 1 μm and multi-wall carbon nanotubes having a diameter of approximately 5 nm is applied by a screen printing method thus forming an electron source layer EMS.

Next, as shown in FIG. 14, to the back substrate SUB1 on which the cathode electrode CL, the electron source layer EMS and the gate electrodes GL are formed, frit glass is applied by a screen printing method and is baked thus forming an insulating layer INS. In the insulating layer INS, gate electrode contact holes GHL which are communicated with the gate electrodes GL are formed at portions thereof which correspond to positions where the gate electrodes GL are formed and the electron source hole CHL which corresponds to the forming position of the electron source layer EMS is formed. A film thickness of the insulating layer INS is approximately 5 μm after baking. Due to such a constitution, inside of the electron source hole CHL, the electron source layer EMS which is formed on the cathode electrode CL and a portion of the gate electrodes GL arranged close to the cathode electrode CL are exposed.

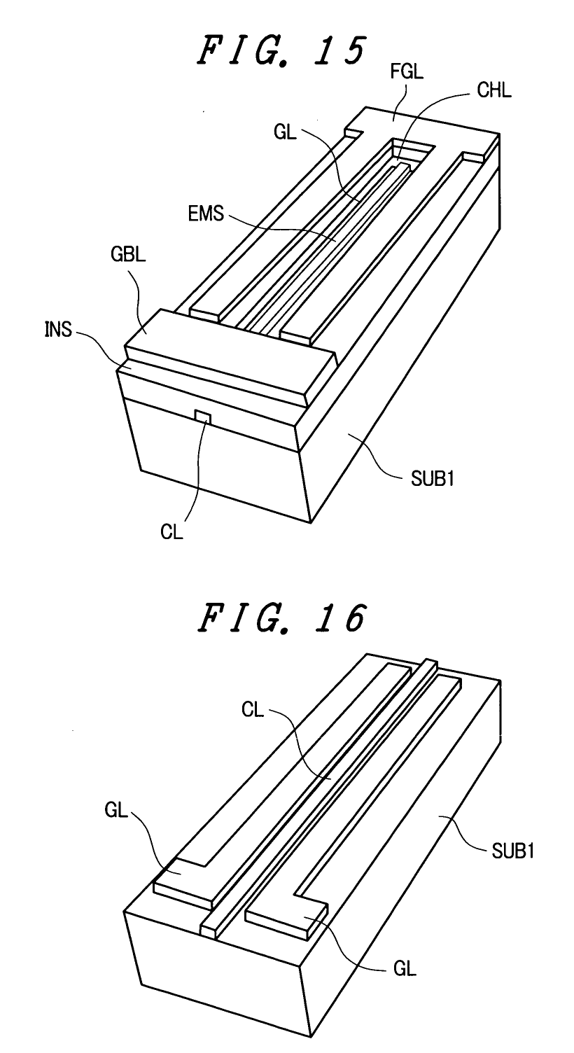

Next, as shown in FIG. 15, a silver paste which is formed by impregnating silver fine particles into an organic solvent is applied to the insulating layer INS by a screen printing method and is baked thus simultaneously forming a gate electrode bus line GBL and a focusing gate electrode FGL. The gate electrode bus line GBL and the focusing gate electrode FGL contain silver fine particles having a particle size of approximately 1 μm and a film thickness of the gate electrode bus line GBL and the focusing gate electrode FGL is approximately 5 μm after baking. 720 pieces of gate electrode bus lines GBL and 720 pieces of focusing gate electrodes FGL are formed respectively.

Finally, the surface treatment for forming bristled carbon nanotubes is performed with respect to a surface of the electron source layer EMS which is exposed inside of the electron source hole CHL. The surface treatment can be performed using a technique such as the laser irradiation, the plasma treatment or the mechanical treatment. In this manner, it is possible to form the carbon nanotubes electron source structure which can perform the gate operation and the electron beam focusing.

The electron source structure having such a structure can, by applying a positive or negative voltage with respect to the cathode electrode CL to the focusing gate electrode FGL, control a spreading angle of emission beams from the electron source layer EMS.

Here, in this embodiment, although the cathode electrode CL, the gate electrode GL, the gate electrode bus line GBL and the focusing gate electrode FGL are made of silver, it is possible to use any metal which possesses the necessary electric conductivity. Further, it is also possible to use alloy or a metal multi-layered film. Still further, the formation by coating of the cathode electrode CL, the gate electrode GL, the gate electrode bus line GBL and the focusing gate electrode FGL is not limited to the screen printing method and an ink jet method, other pecullar printing methods, an epitaxial growth method or the like can be also used.

### Embodiment 3

FIG. 16 to FIG. 21 are explanatory views of another structural examples of the back panel and the manufacturing process for manufacturing the structural examples in the emissive flat panel display device according to the present invention. Here, in these drawings, a sub pixel of the electron source array formed in the display region is described in detail in these drawings.

First of all, as shown in FIG. 16, to the back substrate SUB1 which is preferably made of a glass plate, a silver paste which is formed by impregnating silver fine particles into an organic solvent is applied by a screen printing method in a stripe shape and, thereafter, the paste is baked so as to form the stripe structure of the cathode electrodes CL and the stripe structure of the gate electrodes GL simultaneously. The cathode electrodes CL and the gate electrodes GL are formed on a same plane of the back substrate SUB1. A width of the stripe structure of the cathode electrode CL is approximately 30 μm and a distance between the cathode electrode CL and a stripe-shape cathode electrode arranged adjacent to the cathode electrode CL is approximately 240 μm, and a distance between the cathode electrode CL and the gate electrode GL is approximately 30 μm.

The cathode electrode CL and the gate electrodes GL are constituted of silver fine particles having a particle size of approximately 1 μm and a film thickness of the cathode electrode CL and the gate electrode GL after baking is approximately 5 μm. 3840 pieces (1280×3) of cathode electrodes CL having the stripe structure are formed.

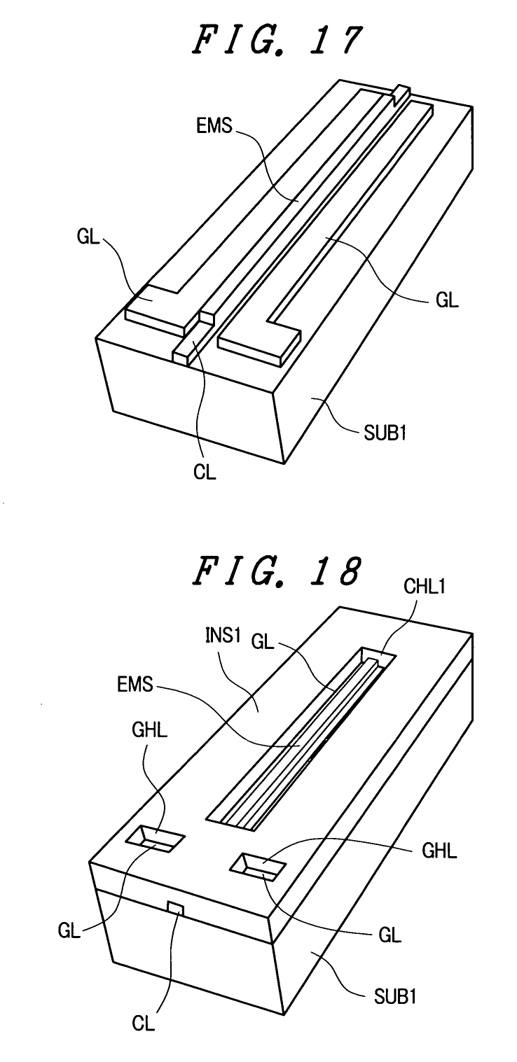

Next, as shown in FIG. 17, to a surface of the cathode electrode CL, a silver paste which is formed by allowing an organic solvent to contain the silver fine particles having a particle size of approximately 1 μm and multi-wall carbon nanotubes having a diameter of approximately 5 nm is applied by a screen printing method thus forming an electron source layer EMS.

Next, as shown in FIG. 18, to the back substrate SUB1 on which the cathode electrode CL and the gate electrodes GL are formed, frit glass is applied by a screen printing method and is baked thus forming an insulating layer INS1. In the insulating layer INS1, gate electrode contact holes GHL which are communicated with the gate electrodes GL are formed at portions thereof which correspond to positions where the gate electrodes GL are formed and an electron source hole CHL1 is formed at a portion which corresponds to the forming position of the electron source layer EMS. A film thickness of the insulating layer INS1 is approximately 5 μm after baking. Due to such a constitution, inside of the electron source hole CHL1, the electron source layer EMS which is formed on the cathode electrode CL and portions of the gate electrodes GL arranged close to the cathode electrode CL are exposed.

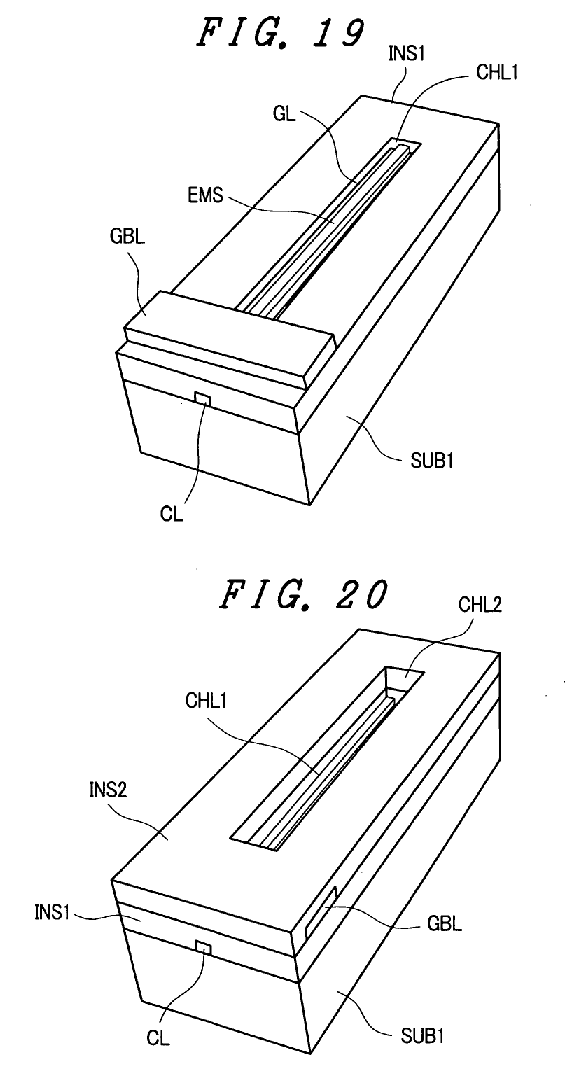

Next, as shown in FIG. 19, a silver paste which is formed by impregnating silver fine particles into an organic solvent is applied to the insulating layer INS1 by a screen printing method and is baked thus forming a gate electrode bus line GBL. The gate electrode bus line GBL is constituted of silver fine particles having a particle size of approximately 1 μm and a film thickness of the gate electrode bus line GBL is approximately 5 μm after baking. 720 pieces of gate electrode bus lines GBL are formed respectively.

Next, as shown in FIG. 20, to the insulating layer INS1 on which the gate electrode bus line GBL is formed, frit glass is applied by a screen printing method and is baked thus forming an upper insulating layer INS2. In the insulating layer INS2, an electron source hole CHL2 which is communicated with the electron source hole CHL1 and has an opening equal to an opening of electron source hole CHL1 at a position which corresponds to the above-mentioned electron source layer ESM is formed. Here, a film thickness of the upper insulating layer INS2 is approximately 5 μm after baking.

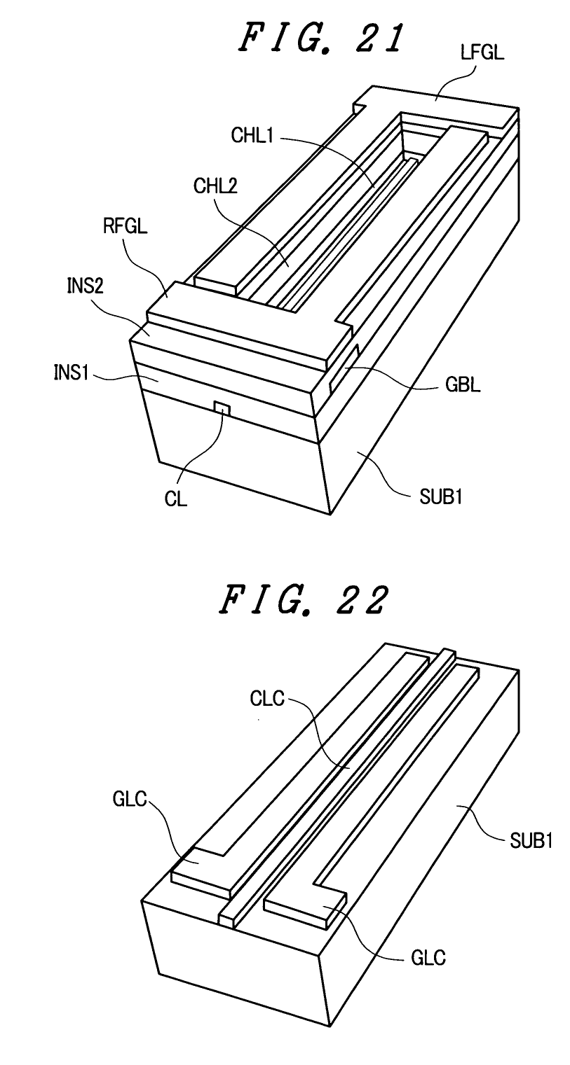

Next, as shown in FIG. 21, a silver paste which is formed by impregnating silver fine particles into an organic solvent is applied to the insulating layer INS2 by a screen printing method is baked thus simultaneously forming a first focusing gate electrode FGL1 and a second focusing gate electrode FGL2 which are electrically separated. The first focusing gate electrode FGL1 and the second focusing gate electrode FGL2 are constituted of silver fine particles having a particle size of approximately 1 μm and a film thickness of the first focusing gate electrode FGL1 and the second focusing gate electrode FGL2 after baking is approximately 5 μm. 720 pieces of the first focusing gate electrode FGL1 and 720 pieces of the second focusing gate electrode FGL2 are formed respectively.

Finally, the surface treatment for forming bristled carbon nanotubes is performed with respect to a surface of the electron source layer EMS which is exposed inside of the electron source hole CHL2. The surface treatment can be performed using a technique such as the laser irradiation, the plasma treatment or the mechanical treatment. In this manner, it is possible to form the carbon nanotubes electron source structure which can perform the gate operation and the electron beam focusing.

The electron source structure having such a structure can, by applying a positive or negative voltage with respect to the cathode electrode CL to the first focusing gate electrode FGL1 and the second focusing gate electrode FGL2, control a spreading angle of emission beams from the electron source layer EMS.

Here, in this embodiment, although the cathode electrode CL, the gate electrodes GL, the gate electrode bus line GBL and the first focusing gate electrode FGL1 and the second focusing gate electrode FGL2 are made of silver, it is possible to use any metal which possesses the necessary electric conductivity. Further, it is also possible to use alloy or a metal multi-layered film. Still further, the formation by coating of the cathode electrode CL, the gate electrodes GL, the gate electrode bus line GBL and the first focusing gate electrode FGL1 and the second focusing gate electrode FGL2 is not limited to the screen printing method and an ink jet method, other peculiar printing methods, an epitaxial growth method or the like can be also used.

### Embodiment 4

FIG. 22 to FIG. 27 are explanatory views of another structural example of the back panel and the manufacturing process for manufacturing the structural examples in the emissive flat panel display device according to the present invention. Here, in these drawings, a sub pixel of the electron source array formed in the display region is explained.

First of all, as shown in FIG. 22, to the back substrate SUB1 which is preferably made of a glass plate, an electrode forming silver paste which is formed by impregnating silver fine particles into an organic solvent and multi-wall carbon nanotubes is applied by a screen printing method in a stripe shape and, thereafter, the paste is baked so as to form a cathode electrode CL and gate electrodes GL simultaneously. These cathode electrodes CL and gate electrodes GL are formed on a same plane of the back substrate SUB1. A width of the cathode electrode CL is approximately 30 μm and a distance between the cathode electrode CL and a stripe-shape cathode electrode arranged adjacent to the cathode electrode CL is approximately 240 μm. Further, a distance between the cathode electrode CL and the gate electrode GL is approximately 30 μm.

The cathode electrode CL and the gate electrode GL is constituted of a compound formed of silver fine particles having a particle size of approximately 1 μm and a multi-wall carbon nanotubes having a diameter of approximately 5 nm and a film thickness of the cathode electrode CL and the gate electrode GL after baking is approximately 5 μm. 3840 pieces (1280×3) of cathode electrodes CL having the stripe structure are formed.

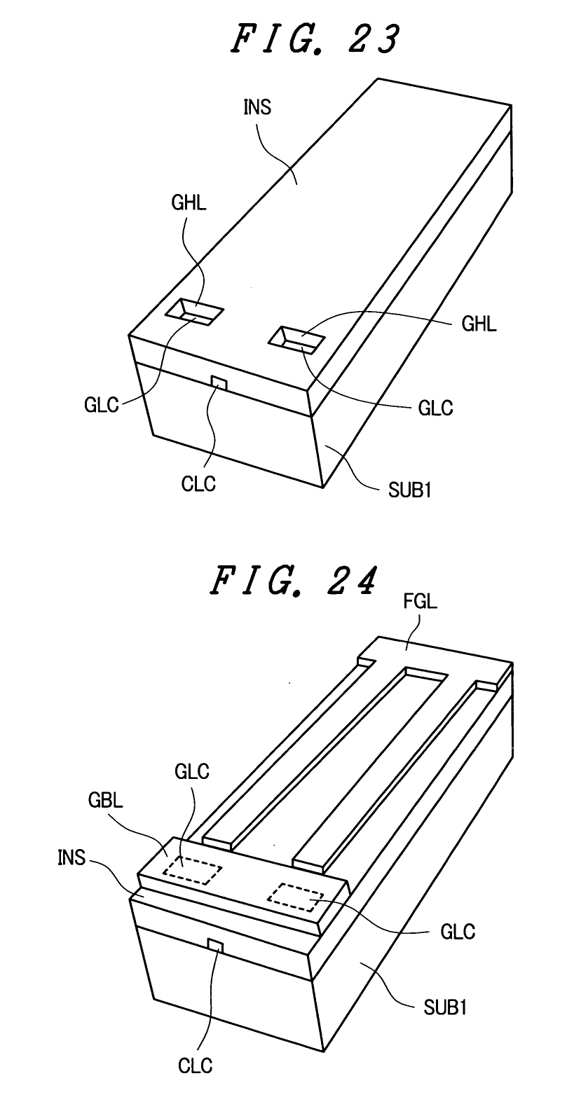

Next, as shown in FIG. 23, to the back substrate SUB1 on which the cathode electrode CL and the gate electrode GL are formed, frit glass is applied by a screen printing method and is baked thus forming an insulating layer INS. In the insulating layer INS, gate electrode contact holes GHL which are communicated with the gate electrodes GL are formed at portions thereof which correspond to positions where the gate electrodes GL are formed. A film thickness of the insulating layer INS is approximately 5 μm after baking.

Next, as shown in FIG. 24, an electrode forming silver paste which is formed by impregnating silver fine particles into an organic solvent is applied to portions of the insulating layer INS which correspond to the gate electrode contact holes GHL and predetermined portions of the insulating layer INS by a screen printing method and is baked thus simultaneously forming a gate electrode bus line GBL and a focusing gate electrode FGL. The gate electrode bus line GBL and the focusing gate electrode FGL are constituted of silver fine particles having a particle size of approximately 1 μm and a film thickness of the gate electrode bus line GBL and the focusing gate electrode FGL is approximately 5 μm after baking. 720 pieces of gate electrode bus lines GBL and 720 pieces of focusing gate electrodes FGL are formed respectively.

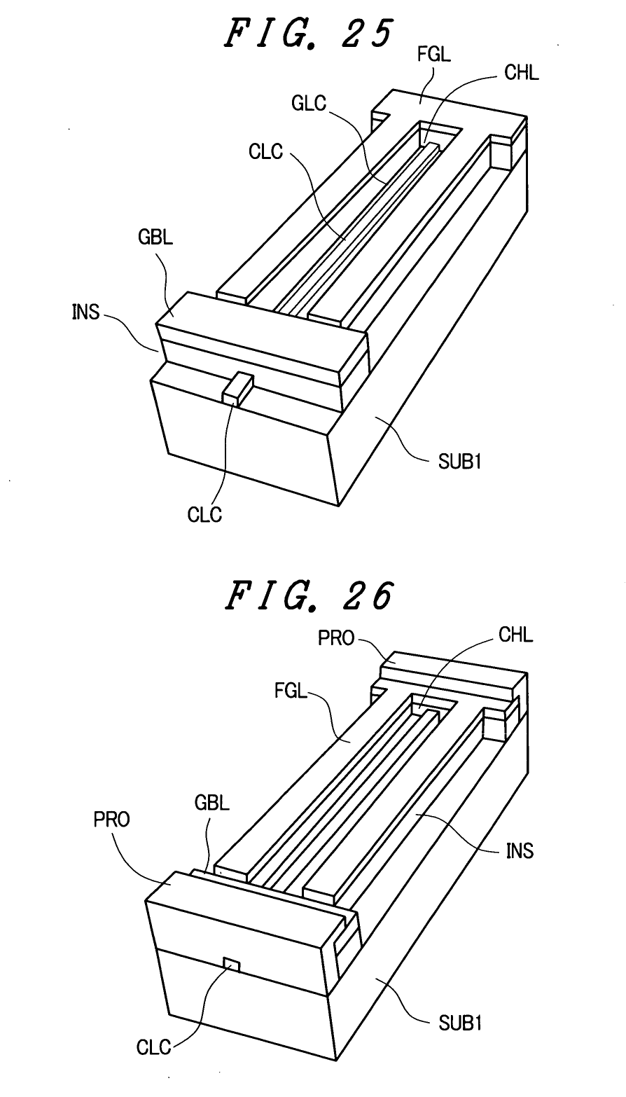

Next, as shown in FIG. 25, using the gate electrode bus line GBL and the focusing gate electrode FGL as masks, the insulating layer INS is etched by a dry etching method or a wet etching method thus forming an electron source hole CHL. Due to such a constitution, inside of the electron source hole CHL, portions of the cathode electrode CL which contains the multi-wall carbon nanotubes and the gate electrodes GL arranged close to the cathode electrode CL side are exposed.

Next, as shown in FIG. 26, to unnecessarily exposed portions of the gate electrode bus line GBL and the focusing gate electrode FGL, frit glass is applied by a screen printing method and is baked thus forming protective insulating layers PRO.

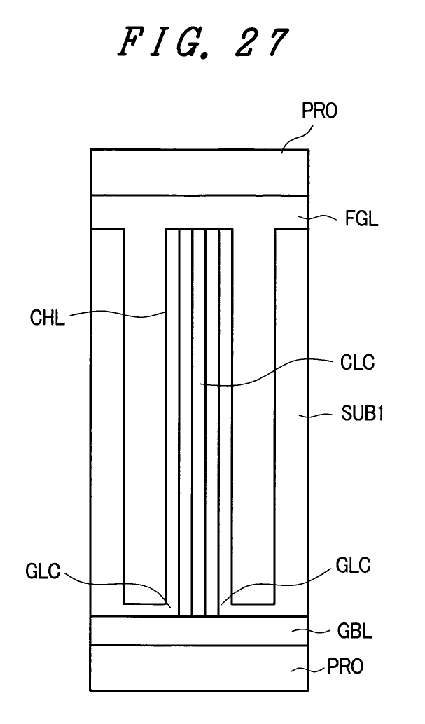

Next, as shown in FIG. 27 which is a plan view of the constitution shown in FIG. 26, surfaces of portions of the gate electrodes GL close to the cathode electrode CL side which is exposed inside of the electron source hole CHL are covered with metal plating thus forming metal films. Further, the surfaces of portions of the gate electrodes GL close to the cathode electrode CL side which is exposed inside of the electron source hole CHL are oxidized by an electrolytic oxidation method so as to oxidize the multi-wall carbon nanotubes thus remarkably lowering the emission function.

Finally, the surface treatment for forming bristled carbon nanotubes is performed with respect to the exposed surface of the cathode electrode CL. The surface treatment can be performed using a technique such as laser irradiation, plasma treatment or mechanical treatment.

In this manner, it is possible to form the multi-wall carbon nanotubes electron source structure which can perform the gate operation and the electron beam focusing.

In such an electron source structure, the cathode electrode CL and the gate electrodes GL are formed adjacent to each other on the substantially coplanar surface of the back substrate SUB1.

The electron source structure having such a structure can, by applying a positive or negative voltage with respect to the cathode electrode CL to the focusing gate electrode FGL, control a spreading angle of emission beams from the cathode electrode CL.

Here, in this embodiment, although the cathode electrode CL, the gate electrodes GL, the gate electrode bus line GBL and the focusing gate electrode FGL are made of silver, it is possible to use any metal which possesses the necessary electric conductivity. Further, it is also possible to use alloy or a metal multi-layered film. Still further, the formation by coating of the cathode electrode CL, the gate electrodes GL, the gate electrode bus line GBL and the focusing gate electrode FGL is not limited to the screen printing method and an ink jet method, other peculiar printing methods, an epitaxial growth method or the like can be also used.

### Embodiment 5

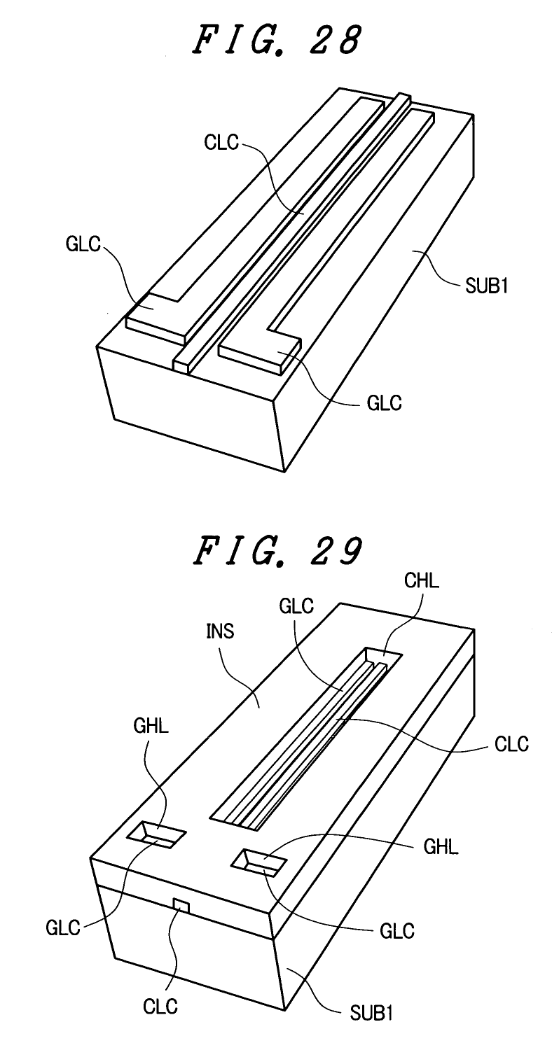

FIG. 28 to FIG. 31 are explanatory views of another structural example of the back panel and the manufacturing process for manufacturing the structural example in the emissive flat panel display device according to the present invention. Here, in these drawings, a sub pixel of the electron source array formed in the display region is explained.

First of all, as shown in FIG. 28, to the back substrate SUB1 which is preferably made of a glass plate, an electrode forming silver paste which is formed by impregnating silver fine particles into an organic solvent and multi-wall carbon nanotubes is applied by a screen printing method in a stripe shape and, thereafter, the paste is baked so as to form a cathode electrode CL and the gate electrodes GL simultaneously. These cathode electrode CL and gate electrode GL are formed on a substantially same plane on the back substrate SUB1. A width of the cathode electrode CL is approximately 30 μm and a distance between the cathode electrode CL and a stripe-shape cathode electrode arranged adjacent to the cathode electrode CL is approximately 240 μm. Further, a distance between the cathode electrode CL and the gate electrodes GL is approximately 30 μm.

The cathode electrode CL and the gate electrodes GL are constituted of a compound formed of silver fine particles having a particle size of approximately 1 μm and a multi-wall carbon nanotubes having a diameter of approximately 5 nm and a film thickness of the cathode electrode CL and the gate electrodes GL after baking is approximately 5 μm. 3840 pieces (1280×3) of cathode electrodes CL having the stripe structure are formed.

Next, as shown in FIG. 29, to the back substrate SUB1 on which the cathode electrode CL and the gate electrodes GL are formed, frit glass is applied by a screen printing method and is baked thus forming an insulating layer INS. In portions of the insulating layer INS which correspond to positions where the gate electrodes GL are formed, gate electrode contact holes GHL which are communicated with the gate electrodes GL is formed, while in a portion of the insulating layer INS which corresponds to the electron source portion, an electron source hole CHL is formed. Here, the gate electrode contact holes GHL and the electron source hole CHL are integrally formed. A film thickness of the insulating layer INS is approximately 5 μm after baking. Due to such a constitution, inside of the electron source hole CHL, the cathode electrode CL and portions of the gate electrodes GL arranged close to the cathode electrode CL are exposed.

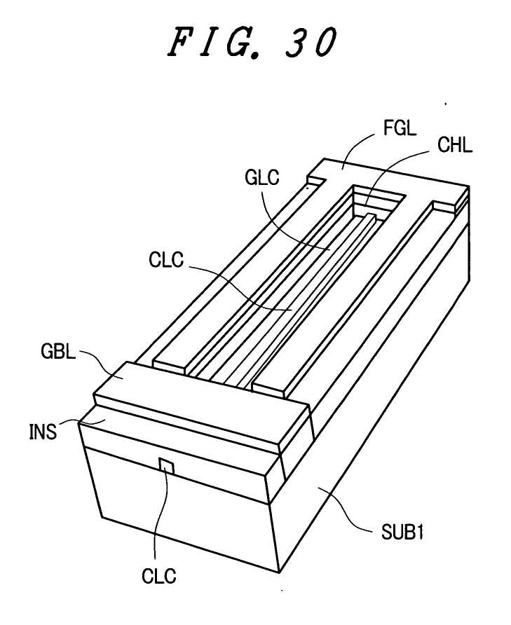

Next, as shown in FIG. 30, a silver paste which is formed by impregnating silver fine particles into an organic solvent is applied to the insulating layer INS by a screen printing method and is baked thus simultaneously forming a gate electrode bus line GBL and a focusing gate electrode FGL. The gate electrode bus line GBL and the focusing gate electrode FGL are constituted of silver fine particles having a particle size of approximately 1 μm and a film thickness of the gate electrode bus line GBL and the focusing gate electrode FGL is approximately 5 μm after baking. 720 pieces of gate electrode bus lines GBL and 720 pieces of focusing gate electrodes FGL are formed respectively.

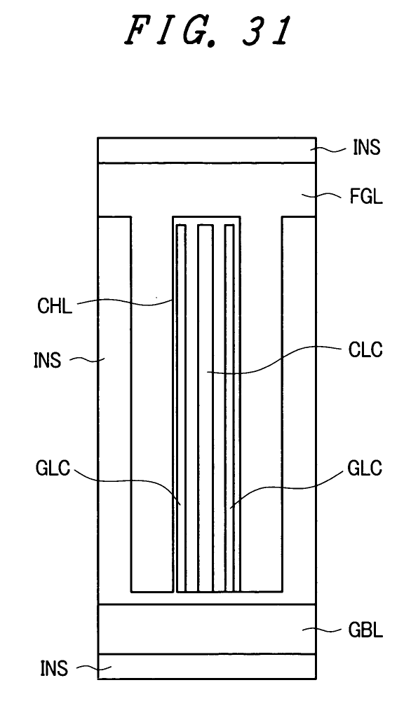

Next, as shown in FIG. 31 which is a plan view of the constitution shown in FIG. 30, surfaces of portions of the gate electrodes GL close to the cathode electrode CL side which is exposed inside of the electron source hole CHL is covered with metal plating thus forming metal films. Further, the surfaces of the portions of the gate electrodes GL close to the cathode electrode CL side which are exposed inside of the electron source hole CHL are oxidized by an electrolytic oxidation method so as to oxidize the multi-wall carbon nanotubes thus remarkably lowering the emission function.

Finally, the surface treatment for forming bristled multi-wall carbon nanotubes is performed with respect to the surface of the cathode electrode CL exposed in the electron source hole CHL. The surface treatment can be performed using a technique such as laser irradiation, plasma treatment or mechanical treatment.

In this manner, it is possible to form the carbon nanotubes electron source structure which can perform the gate operation and the electron beam focusing.

The electron source structure having such a structure can, by applying a positive or negative voltage with respect to the cathode electrode CL to the focusing gate electrode FGL, control a spreading angle of emission beams from the cathode electrode CL.

Here, in this embodiment, although the cathode electrode CL, the gate electrodes GL, the gate electrode bus line GBL and the focusing gate electrode FGL are made of silver, it is possible to use any metal which possesses the necessary electric conductivity. Further, it is also possible to use alloy or a metal multi-layered film. Still further, the formation by coating of the cathode electrode CL, the gate electrodes GL, the gate electrode bus line GBL and the focusing gate electrode FGL is not limited to the screen printing method and an ink jet method, other peculiar printing methods, an epitaxial growth method or the like can be also used.

### Embodiment 6

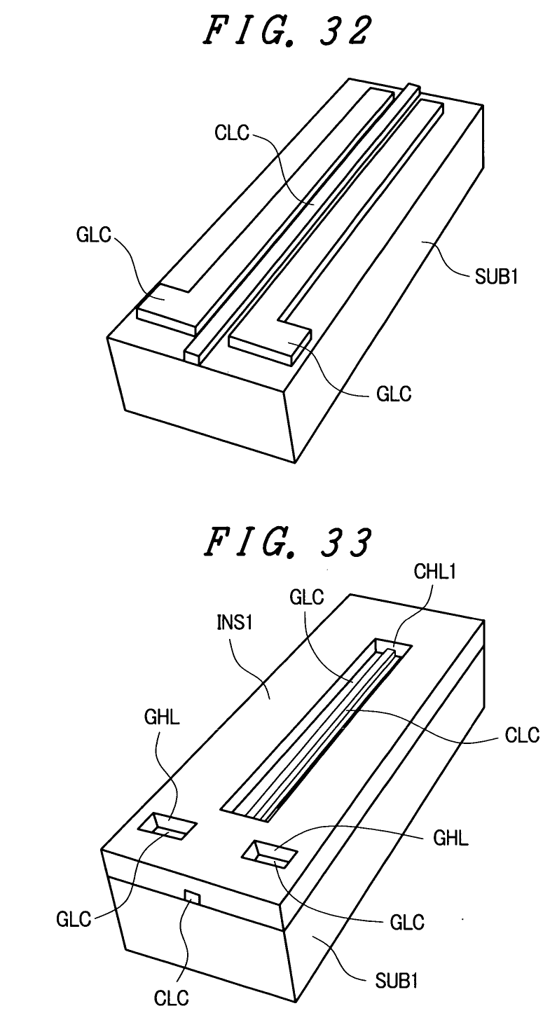

FIG. 32 to FIG. 37 are explanatory views of another structural example of the back panel and the manufacturing process for forming the structural example in the emissive flat panel display device according to the present invention. Here, in this embodiment, a sub pixel of the electron source array formed in the display region is explained.

First of all, as shown in FIG. 32, to the back substrate SUB1 which is preferably made of a glass plate, an electrode forming silver paste which is formed by impregnating silver fine particles into an organic solvent and multi-wall carbon nanotubes is applied by a screen printing method in a stripe shape and, thereafter, the paste is baked so as to form stripe structure of a cathode electrode CL and the stripe structure of the gate electrodes GL simultaneously. These cathode electrode CL and gate electrodes GL are formed on a substantially same plane of the back substrate SUB1. A width of the cathode electrode CL is approximately 30 μm and a distance between the cathode electrode CL and a stripe-shape cathode electrode arranged close to the cathode electrode CL is approximately 240 μm. Further, a distance between the cathode electrode CL and the gate electrodes GL is approximately 30 μm.

The cathode electrode CL and the gate electrodes GL are constituted of a mixture formed of silver fine particles having a particle size of approximately 1 μm and multi-wall carbon nanotubes having a diameter of approximately 5 nm and a film thickness of the cathode electrode CL and the gate electrodes GL after baking is approximately 5 μm. 3840 pieces (1280×3) of cathode electrodes CL having the stripe structure are formed.

Next, as shown in FIG. 33, to the back substrate SUB1 on which the cathode electrode CL and the gate electrodes GL are formed, frit glass is applied by a screen printing method and is baked thus forming an insulating layer INS1. In portions of the insulating layer INS1 which correspond to positions where the gate electrodes GL are formed, gate electrode contact holes GHL which are communicated with the gate electrodes GL are formed, while in a portion of the insulating layer INS1 which corresponds to an electron source portion, an electron source hole CHL is formed. Here, the gate electrode contact holes GHL and the electron source hole CHL are integrally formed. A film thickness of the insulating layer INS1 is approximately 5 μm after baking. Due to such a constitution, inside of the electron source hole CHL1, the cathode electrode CL and portions of the gate electrodes GL arranged close to the cathode electrode CL side are exposed.

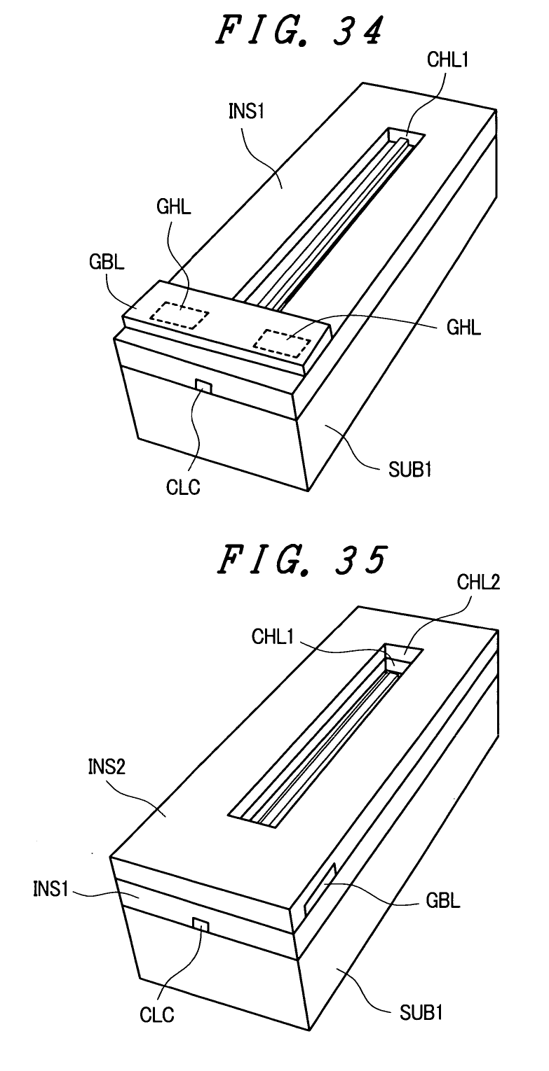

Next, as shown in FIG. 34, a silver paste which is formed by impregnating silver fine particles into an organic solvent is applied to the insulating layer INS1 by a screen printing method and is baked thus simultaneously forming a gate electrode bus line GBL. The gate electrode bus line GBL is constituted of silver fine particles having a particle size of approximately 1 μm and a film thickness of the gate electrode bus line GBL is approximately 5 μm after baking. 720 pieces of gate electrode bus lines GBL and 720 pieces of focusing gate electrodes FGL are formed respectively.

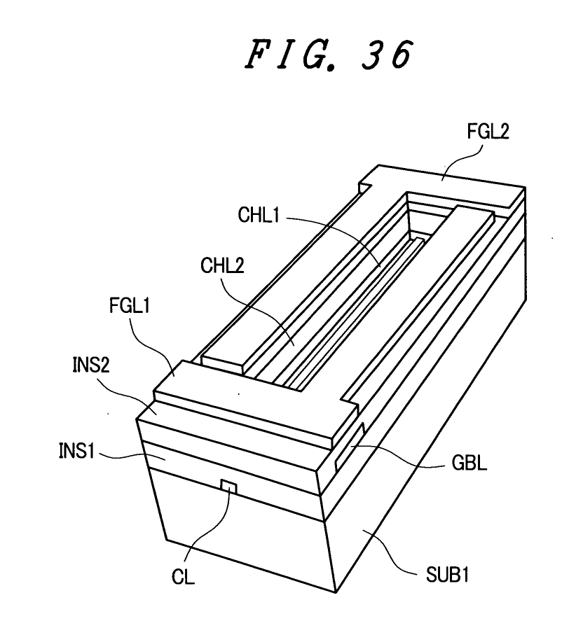

Next, as shown in FIG. 35, to the insulating layer INS1 on which the gate electrode bus line GBL is formed, frit glass is applied by a screen printing method and is baked thus forming an upper insulating layer INS2. In the insulating layer INS2, the electron source hole CHL2 which is communicated with the electron source hole CHL1 and has an opening equal to an opening of electron source hole CHL1 at a position which corresponds to the electron source portion is formed. Here, a film thickness of the upper insulating layer INS2 is approximately 5 μm after baking.

Next, as shown in FIG. 36, an electrode forming silver paste which is formed by impregnating silver fine particles into an organic solvent is applied to the insulating layer INS2 by a screen printing method and is baked thus simultaneously forming a first focusing gate electrode FGL1 and a second focusing gate electrode FGL2. The first focusing gate electrode FGL1 and the second focusing gate electrode FGL2 are constituted of silver fine particles having a particle size of approximately 1 μm and a film thickness of the first focusing gate electrode FGL1 and the second focusing gate electrode FGL2 is approximately 5 μm after baking. 720 pieces of such first focusing gate electrode FGL1 and 720 pieces of such second focusing gate electrode FGL2 are formed respectively.

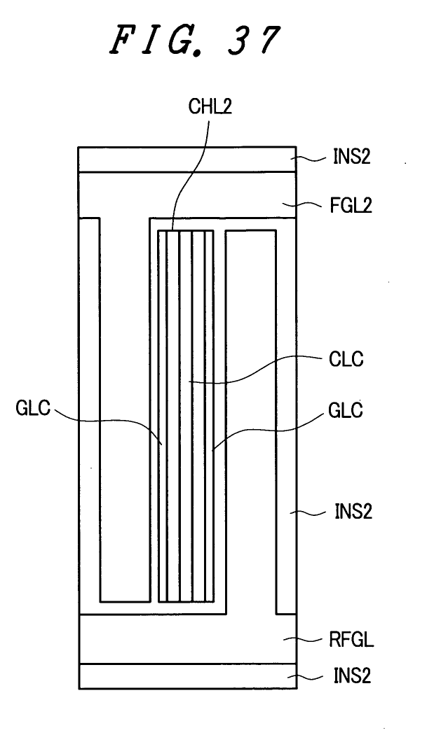

Next, as shown in FIG. 37 which is a plan view of the constitution shown in FIG. 36, surfaces of portions of the gate electrodes GL close to the cathode electrode CL side which are exposed inside of the upper electron source hole CHL2 are covered with metal plating thus forming metal films. Further, the surfaces of the portions of the gate electrodes GL close to the cathode electrode CL side which are exposed inside of the upper electron source hole CHL2 are oxidized by an electrolytic oxidation method so as to oxidize the multi-wall carbon nanotubes thus remarkably lowering the emission function.

Finally, the surface treatment for forming bristled multi-wall carbon nanotubes is performed with respect to the surface of the cathode electrode CL exposed in the electron source hole CHL2. The surface treatment can be performed using a technique such as laser irradiation, plasma treatment or mechanical treatment. In this manner, it is possible to manufacture the carbon nanotubes electron source structure which can perform the gate operation and the electron beam focusing.

The electron source structure having such a structure can, by applying a positive voltage or a negative voltage with respect to the cathode electrode CL to the first focusing gate electrode FGL1 and the second focusing gate electrode FGL2, control a spreading angle of emission beams from the cathode electrode CL.

Here, in this embodiment, although the cathode electrode CL, the gate electrodes GL, the gate electrode bus line GBL, the first focusing gate electrode FGL1 and the second focusing gate electrode FGL2 are made of silver, it is possible to use any metal which possesses the necessary electric conductivity. Further, it is also possible to use alloy or a metal multi-layered film. Still further, the formation by coating of the cathode electrode CL, the gate electrodes GL, the gate electrode bus line GBL, the first focusing gate electrode FGL1 and the second focusing gate electrode FGL2 is not limited to the screen printing method and an ink jet method, other peculiar printing methods, an epitaxial growth method or the like can be also used.

In this manner, it is possible to form the multi-wall carbon nanotubes electron source structure which can perform the gate operation and the electron beam focusing.

In such an electron source structure, the cathode electrode CL and the gate electrodes GL are formed close to each other on the substantially coplanar surface of the back substrate SUB1.

The electron source structure having such structure can, by applying a positive or negative voltage with respect to the cathode electrode CL to the first focusing gate electrode FGL1 and the second focusing gate electrode FGL2, control a spreading angle of emission beams from the cathode electrode CL.

Here, in this embodiment, although the cathode electrode CL, the gate electrodes GL, the gate electrode bus line GBL, the first focusing gate electrode FGL1 and the second focusing gate electrode FGL2 are made of silver, it is possible to use any metal which possesses the necessary electric conductivity. Further, it is also possible to use alloy or a metal multi-layered film. Still further, the formation by coating of the cathode electrode CL, the gate electrodes GL, the gate electrode bus line GBL, the first focusing gate electrode FGL1 and the second focusing gate electrode FGL2 is not limited to the screen printing method and an ink jet method, other peculiar printing methods, an epitaxial growth method or the like can be also used.

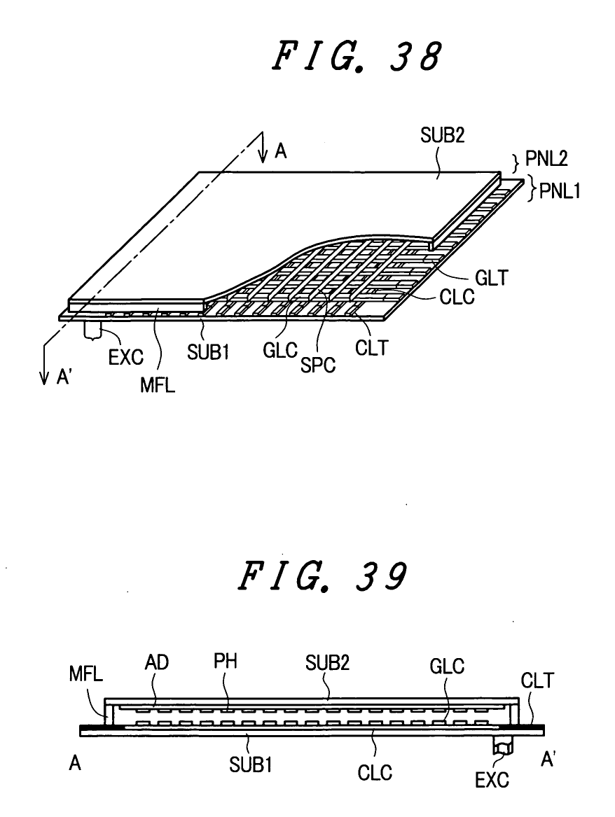

FIG. 38 is a perspective view with a part broken away for explaining one example of the whole structure of the emissive flat panel display device according to the present invention. Further, FIG. 39 is a cross-sectional view taken along a line A-A′ in FIG. 38. On the inner surface of the back substrate SUB1 which constitutes the back panel PNL1, the cathode electrodes CL and the gate electrodes GL are formed, wherein the electron sources are formed on the intersecting portions of the cathode electrodes CL and the gate electrodes GL. The cathode electrode lead line CLT is formed at end portions of the cathode electrodes CL, while the gate electrode lead line GLT is formed at end portions of the gate electrodes GL.

On an inner surface of the face substrate SUB2 which constitutes the face panel PNL2, the above-mentioned anode electrode and phosphor layers are formed. The back substrate SUB1 which constitutes the back panel PNL1 and the face substrate SUB2 which constitutes the face panel PNL2 are laminated to each other by interposing the sealing frame MFL between the peripheries of these panels. To maintain a gap between the laminated panels at a predetermined value, partition walls SPC which are preferably formed of a glass plate are erected between the back substrate SUB1 and the face panel PNL2. FIG. 39 shows a cross section along the partition wall SPC and hence, the partition walls SPC are omitted.

Here, the inner space which is hermetically sealed by the back panel SUB1, the face panel PNL2 and the sealing frame MFL is evacuated through an exhaust pipe EXC formed in a portion of the back panel PNL1 to create a predetermined vacuum state.

What is claimed is:

1. An emissive flat panel display device comprising:
a back panel which includes cathode electrodes which extend in a first direction, are arranged in parallel in a second direction which intersects the first direction and include electron sources on surfaces thereof, and gate electrodes which extend in the second direction, are arranged in parallel in the first direction and to which a potential which controls a quantity of electrons emitted from the electron sources at intersecting portions with the cathode electrodes is applied, and focusing gate electrodes which are electrically insulated from the cathode electrodes and the gate electrodes and controls a spreading angle of electron beams emitted from the electrons sources on the cathode electrodes; and
a face panel which includes a plurality of phosphor layers of plural colors which emit lights upon excitation of the electrons emitted from the electron and an anode electrode, wherein the display device includes a cathode electrode bus line which electrically connects the cathode electrodes, a gate electrode bus line which electrically connects the gate electrodes, and a focusing gate electrode bus line which electrically connect the focusing gate, and
the electrode structure in which two electrodes out of the cathode electrode, the gate electrode and the focusing electrode are formed on a same plane adjacent to each other is provided in plural stages.

2. An emissive flat panel display device according to claim 1, wherein the cathode electrode and the gate electrode are formed in the first stage, and the gate electrode bus line and the focusing gate electrode are formed on the second stage.

3. An emissive flat panel display device according to claim 1, wherein the cathode electrode and the gate electrode are formed in the first stage, the gate electrode bus line is formed on the second stage, and the focusing gate electrode is formed on the third stage in a state that the focusing gate electrode is electrically separated into a first focusing gate electrode and a second focusing gate electrode.

4. An emissive flat panel display device according to claim 1, wherein an electron source layer which contains a nanomaterial is formed on a surface of the cathode electrode.

5. An emissive flat panel display device according to claim 1, wherein the cathode electrode and the gate electrode contain a nanomaterial which constitutes the electron source.

6. An emissive flat panel display device according to claim 1, wherein a plurality of partition walls are formed between the back panel and the face panel.

7. An emissive flat panel display device according to claim 2, wherein an electron source layer which contains a nanomaterial is formed on a surface of the cathode electrode.

8. An emissive flat panel display device according to claim 2, wherein the cathode electrode and the gate electrode contain a nanomaterial which constitutes the electron source.

9. An emissive flat panel display device according to claim 2, wherein a plurality of partition walls are formed between the back panel and the face panel.

10. An emissive flat panel display device according to claim 3, wherein an electron source layer which contains a nanomaterial is formed on a surface of the cathode electrode.

11. An emissive flat panel display device according to claim 3, wherein the cathode electrode and the gate electrode contain a nanomaterial which constitutes the electron source.

12. An emissive flat panel display device according to claim 3, wherein a plurality of partition walls are formed between the back panel and the face panel.

13. An emissive flat panel display device according to claim 4, wherein the nanomaterial which constitutes the electron source is a material selected from nanotubes, nanocoil or a nano-sized material which is made of carbon and nanotubes, nanocoil or a nano-sized material which contains two elements or more out of three elements consisting of carbon, boron and nitrogen.

14. An emissive flat panel display device according to claim 4, wherein a plurality of partition walls are formed between the back panel and the face panel.

15. An emissive flat panel display device according to claim 5, wherein the nanomaterial which constitutes the electron source is a material selected from nanotubes, nanocoil or a nano-sized material which is made of carbon and nanotubes, nanocoil or a nano-sized material which contains two elements or more out of three elements consisting of carbon, boron and nitrogen.

16. An emissive flat panel display device according to claim 5, wherein a plurality of partition walls are formed between the back panel and the face panel.
